(19) United States
(12) Patent Application Publication
(10) Pub. No.: US 2018/0139776 A1
(43) Pub. Date: May 17, 2018

(54) WIRELESS DEVICE AND RANDOM ACCESS METHOD THEREOF FOR MOBILE COMMUNICATION SYSTEM

(71) Applicant: Institute For Information Industry, Taipei (TW)

(72) Inventors: Ming-Ju WU, Taipei City (TW); Chung-Hsiu CHUNG, Taipei City (TW)

(21) Appl. No.: 15/363,907

(22) Filed: Nov. 29, 2016

(30) Foreign Application Priority Data
Nov. 16, 2016 (TW) 105137452

(51) Int. Cl. H04W 74/00; H04W 74/08

(52) U.S. Cl. CPC H04W 74/004; H04W 84/042; H04W 74/0833

(57) ABSTRACT

A wireless device and a random access method thereof for a mobile communication system are provided. The mobile communication system defines a plurality of preambles and a plurality of preamble subsets. Each preamble subset includes a part of the preambles and the union of the preamble subsets is all of the preambles. The preamble subsets have a set inclusion relationship therebetween, i.e., the larger preamble subset includes the smaller preamble subset. The wireless devices have priority levels and the wireless devices with different priority levels can use different groups of preamble subsets. When performing the random access procedure, the wireless device selects a preamble from the smallest preamble subset corresponding to its priority level. Afterwards, when the request for random access fails, the wireless device sequentially selects a preamble from the larger preamble subset.

### PRIORITY

This application claims priority to Taiwan Patent Application No. 105137452 filed on Nov. 16, 2016, which is hereby incorporated by reference in its entirety.

### FIELD

The present invention relates to a wireless device and a random access method thereof for a mobile communication system. More particularly, the mobile communication system of the present invention defines a plurality of preamble subsets having a set inclusion relationship therebetween. As a result, the wireless device can randomly select a preamble to be used in a random access procedure sequentially from a minimum preamble subset to a larger preamble subset based on a priority value assigned to the wireless device when a random access request fails.

### BACKGROUND

With the rapid development of the wireless communication technology, people's demand for the communication through the user equipments (UEs), e.g., smart phones, tablet computers, etc., increases correspondingly. To satisfy the requirements of the users, new generations of mobile communication systems are being developed continuously, e.g., Long Term Evolution (LTE) communication systems, Worldwide Interoperability for Microwave Access (WiMAX) communication systems or the like.

In these mobile communication systems, a random access procedure may be performed by a user device to obtain radio resources for subsequent data transmission with the base station when the user device is booting up, is disconnected from the network or fails to synchronize with a base station, thereby obtaining radio resources for subsequent data transmission with the base station. In the random access procedure, the user device transmits a random access request message on a particular channel learned from the broadcast message transmitted by the base station. The user device randomly selects one of a plurality of preambles defined by the communication system to generate a random access request message based on the selected preamble.

However, in addition to the common user devices, more and more wireless devices of different types and capable of mobile communication have emerged in recent years, e.g., Internet of Things (IoT) devices, Machine Type Communication (MTC) wireless devices or the like. When a large number of wireless devices (i.e., user devices which are used in people's daily life), IoT devices, MTC devices and various wireless devices capable of mobile communication) perform the random access procedure at the same time, these wireless devices select a preamble randomly from the plurality of preambles of the same set. Therefore, it is very likely that multiple wireless devices select the same preamble at the same time, thereby causing preamble collisions between random access request messages transmitted by the wireless devices.

Under the circumstance that the probability of preamble collisions increases as the number of the wireless devices increases, the wireless device will re-select a preamble randomly and transmit a random access request message once the preamble collision occurs in the random access procedure. The time required for successfully accomplishing the random access procedure will be prolonged by the operations of re-selecting the preamble randomly and transmitting the random access request message, and the wireless device even stops the random access procedure after the number of transmissions of the random access request messages reaches an upper limit of the system. As a result, data transmission between the wireless device and the base station cannot be achieved, and moreover, some radio resources of the base station lie idle.

Accordingly, an urgent need exists in the art to provide a random access mechanism so as to improve the probability of successfully performing the random access procedure by the wireless devices when the number of the wireless devices keeps increasing, thereby avoiding idleness of the radio resources of the base station.

### SUMMARY

The disclosure includes a random access mechanism for a mobile communication system. The random access mechanism can divide a plurality of preambles defined by the mobile communication system into a plurality of preamble subsets, and the preamble subsets have a set inclusion relationship therebetween, i.e., the larger preamble subset includes the smaller preamble subset. Meanwhile, the random access mechanism of the present invention further assigns different priority levels to the wireless devices and the wireless devices with different priority levels can use different groups of the preamble subsets. Therefore, the wireless device can randomly select a preamble to be used for the random access sequentially from a smaller preamble subset to a larger preamble subset based on the priority level assigned to the wireless device when a random access request fails during the random access procedure. In this way, by the random access mechanism of the present invention, wireless devices with different priority levels can use the different initial preamble subsets for performing the random access procedure different, and the number of preambles that can be used by the wireless device with a low priority level is smaller than the number of preambles that can be used by the wireless device with a high priority level. Therefore, the present invention can effectively reduce the possibility of preamble collisions resulting from the same preamble selected by multiple wireless devices at the same time, thereby improving the probability of successfully performing the random access procedure by the wireless devices and avoiding idleness of the radio resources of the base station.

The disclosure includes a wireless device for a mobile communication system. The mobile communication system can define a plurality of preambles and N preamble subsets, where N is a positive integer. Each of the N preamble subsets has a part of the preambles. The preamble subsets have a set inclusion relationship therebetween. An i^{th} preamble subset includes an (i−1)^{th} preamble subset, where i is a positive integer from 2 to N. The union of the N preamble subsets is all of the preambles. The wireless device comprises a transceiver, a storage and a processor. The storage is configured to store the preambles, the N preamble subsets and a priority value. The priority value corresponds to an initial available preamble subset and a largest available preamble subset. The processor is electrically connected to the transceiver and the storage and is configured to execute the following steps: (a) selecting a preamble randomly from a j^{th} preamble subset, wherein an initial value of j corresponds to the initial available preamble subset and is a positive integer from 1 to N; (b) generating a random access request message according to the selected preamble; (c) transmitting the random access request message to a base station via the transceiver; (d) when a random access response message is not received from the base station via the transceiver within a preset time, determining whether j is equal to m and setting j=j+1 if j is not equal to m, wherein m corresponds to the largest available preamble subset and is a positive integer from the initial value of j to N; and (e) repeating the steps (a) to (d) after the step (d) until the random access response message is received from the base station or until the number of transmissions of the random access request messages reaches a threshold value.

The disclosure also includes a random access method for a wireless device. The wireless device is used in a mobile communication system. The mobile communication system can define a plurality of preambles and N preamble subsets, where N is a positive integer. Each of the N preamble subsets has a part of the preambles. The preamble subsets have a set inclusion relationship therebetween. An i^{th} preamble subset includes an (i−1)^{th} preamble subset, where i a positive integer from 2 to N. The union of the N preamble subsets is all of the preambles. The wireless device comprises a transceiver, a storage and a processor. The storage stores the preambles, the N preamble subsets and a priority value. The priority value corresponds to an initial available preamble subset and a largest available preamble subset. The random access method is executed by the processor and comprises the following steps: (a) selecting a preamble randomly from a j^{th} preamble subset, where an initial value of j corresponds to the initial available preamble subset and is a positive integer from 1 to N; (b) generating a random access request message according to the selected preamble; (c) transmitting the random access request message to a base station via the transceiver; (d) when a random access response message is not received from the base station via the transceiver within a preset time, determining whether j is equal to m and setting j=j+1 if j is not equal to m, wherein m corresponds to the largest available preamble subset and is a positive integer from the initial value of j to N; and (e) repeating the steps (a) to (d) after the step (d) until the random access response message is received from the base station or until the number of transmissions of the random access request messages reaches a threshold value.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view illustrating signal transmission between a base station BS and a user equipment UE1, a user equipment UE2 and a smart meter SM in a mobile communication system MCS of the present invention;

FIG. 2 is a schematic view of a wireless device 1 of the present invention; and

FIG. 3 is a flowchart diagram of a random access method of the present invention.

### DETAILED DESCRIPTION

In the following description, the present invention will be explained with reference to certain example embodiments thereof. It shall be appreciated that these example embodiments are not intended to limit the present invention to any particular example, embodiment, environment, applications or implementations described in these example embodiments. Therefore, description of these example embodiments is only for purpose of illustration rather than to limit the present invention, and the scope claimed in this application shall be governed by the claims.

In the following example embodiments and the attached drawings, elements unrelated to the present invention are omitted from depiction; and dimensional relationships among individual elements in the attached drawings are illustrated only for ease of understanding, but not to limit the actual scale.

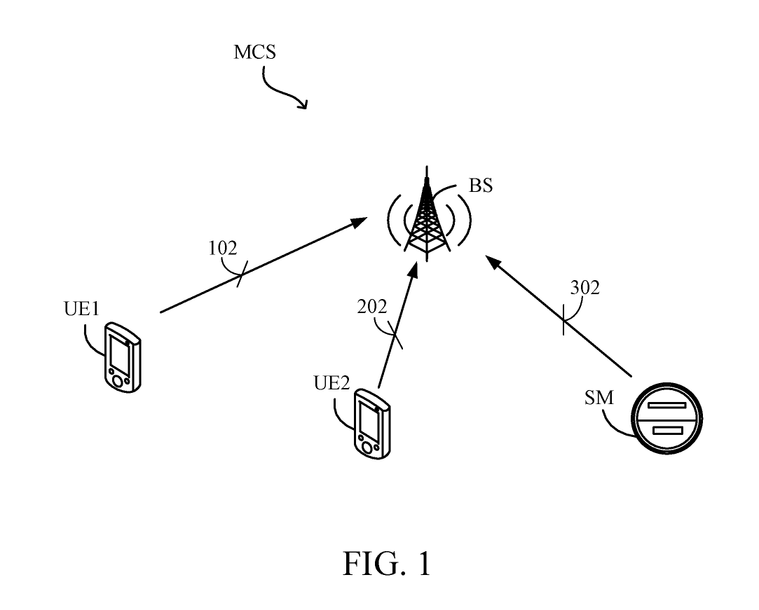

Please refer to FIG. 1 for a first embodiment of the present invention. FIG. 1 is a schematic view depicting signal transmission between a base station BS and several wireless devices (i.e., a user equipment UE1, a user equipment UE2 and a smart meter SM) in a mobile communication system MCS. Each of the user equipment UE1 and the user equipment UE2 may be a smart phone, a tablet computer or any mobile communication device. The smart meter SM is a wireless device with the communication function, and it is usually fixedly mounted on a building to report information about electricity consumption. It shall be appreciated that, the wireless devices of the present invention only need to have the communication function, and are not limited to the aforesaid user equipments UE1 and UE2 and the smart meter SM.

The mobile communication system MCS may be any of mobile communication systems that perform the random access procedure based on a preamble, e.g., Long Term Evolution (LTE) communication systems, Worldwide Interoperability for Microwave Access (WiMAX) communication systems or the like. The mobile communication system MCS defines a plurality of preambles. Taking the LTE communication system as an example, the LTE communication system defines 64 preambles, and the preambles can be generated based on a Zadoff-Chu sequence. The number of preambles in various mobile communication systems and the way in which the preambles are generated are known to those of ordinary skill in the art and thus will not be further described herein.

As compared to the mobile communication system in the prior art, the mobile communication system MCS of the present invention further divides the preambles into N preamble subsets, and N is a positive integer. Each of the N preamble subsets has a part of the preambles, and the N preamble subsets have a set inclusion relationship therebetween. In other words, the i^{th} preamble subset includes the (i−1)^{th} preamble subset, where i a positive integer from 2 to N. The union of the N preamble subsets is all of the preambles.

In detail, X preambles are divided into N preamble subsets, i.e., preamble subsets B₁, B₂, B₃, . . . , B_{N}. Each of the preamble subsets B₁, B₂, B₃, . . . , B_{N} has a part of the X preambles, and the preamble subsets B₁, B₂, B₃, . . . , B_{N} have a set inclusion relationship therebetween. If the preamble sets are presented by mathematical symbols and it is assumed that the X preambles form a total set A, then: A=B₁∪B₂∪B₃ . . . ∪B_{N}, wherein ∪ means the union; B₁⊂B₂⊂B₃⊂B_{N}, where ⊂ means that the former subset is included in the later subset; and |B₁|<|B₂|<|B₃| . . . <|B_{N}|, where |Bₓ| represents the size of the set and B_{N} is equal to the total set A.

Taking the LTE communication system as an example, the mobile communication system MCS of the present invention may further divide the 64 preambles of the LTE communication system into 5 preamble subsets (i.e., N is equal to 5), i.e., the preamble subset B₁ includes preambles of which the sequence numbers are 0 to 3, the preamble subset B₂ includes preambles of which the sequence numbers are 0 to 7, the preamble subset B₃ includes preambles of which the sequence numbers are 0 to 15, the preamble subset B₄ includes preambles of which the sequence numbers are 0 to 31, and the preamble subset B₅ includes preambles of which the sequence numbers are 0 to 63, as shown in Table 1.

TABLE 1

| Preamble subset | Preamble sequence number |
|---|---|
| B₁ | 0-3 |
| B₂ | 0-7 |
| B₃ | 0-15 |
| B₄ | 0-31 |
| B₅ | 0-63 |

Moreover, the mobile communication system MCS of the present invention further assigns a priority value for each of the wireless devices. The priority value may represent a service level, which may be called a priority level, of the wireless device, and each priority value corresponds to an initial available preamble subset and a largest available preamble subset in the N preamble subsets. The initial available preamble subset is the preamble subset that is firstly used by the wireless device when performing the random access procedure. The largest available preamble subset is the largest preamble subset that can be used by the wireless device when performing the random access procedure. The priority value is decided by the operator of the mobile communication system MCS when the user applies the communication service for the wireless device.

Usually, the wireless device that frequently uses the communication service (e.g., the user equipment UE1 and the user equipment UE2 which are the mobile devices used by people) has a higher priority value, and the wireless device that only periodically uses the communication service (e.g., the smart meter SM) has a lower priority value. Moreover, the priority value of each of the user equipments may also be decided according to the service level or the service tariffing applied by the user.

The wireless device can read its priority value from a Subscriber Identity Module (SIM) card installed therein, or acquire and store the priority value thereof via other software or firmware writing manner. In an embodiment, the wireless device may also receive a system message broadcasted by the base station. The system message carries N preamble subsets. Therefore, after receiving the system message, the wireless device can extract N preamble subsets from the system message and store them. However, in another embodiment, the wireless device may also read N preamble subsets from the SIM card installed therein, or acquire and store N preamble subsets via other software or firmware writing manner.

It shall be appreciated that, the correspondence relationships between the priority value and the initial available preamble subset as well as the largest available preamble subset can be established by designing the priority value or via a mapping table (but not limited thereto) so that the wireless device is able to learn the initial available preamble subset and the largest available preamble subset corresponding to the priority value. Therefore, the wireless device may also acquire relevant information about the correspondence relationships between the priority value and the initial available preamble subset as well as the largest available preamble subset from the system message broadcasted by the base station, or read the relevant information about the correspondence relationships between the priority value and the initial available preamble subset as well as the largest available preamble subset from the SIM card installed in the wireless device or acquire the aforesaid relevant information via other software or firmware writing manner. Various representations of the correspondence relationships shall be appreciated by those of ordinary skill in the art based on the aforesaid exemplary examples, and thus will not be further described herein.

When the wireless device initiates a random access procedure, the wireless device selects a preamble randomly from a j^{th} preamble subset, where an initial value of j corresponds to the initial available preamble subset and is a positive integer from 1 to N. Thereafter, the wireless device generates a random access request message according to the selected preamble and transmits the random access request message to the base station. The wireless device determines whether j is equal to m if a random access response message is not received by the wireless device from the base station within a preset time, where m corresponds to the largest available preamble subset and is a positive integer from the initial value of j to N, i.e., m>=j.

The wireless device sets j=j+1 if j is not equal to m. Next, the wireless device repeats the aforesaid operations (i.e., (i) selecting a preamble randomly from the j^{th} preamble subset; (ii) generating a random access request message according to the selected preamble; (iii) transmitting the random access request message to the base station; and (iv) when a random access response message is not received from the base station within a preset time, determining whether j is equal to m and setting j=j+1 if j is not equal to m) until the random access response message is received from the base station or until the number of transmissions of the random access request messages reaches a threshold value. It shall be appreciated that, the threshold value is set depending on specifications of various mobile communication systems or set by the operator of the wireless device depending on practical needs, but it is not limited thereto. The setting of the threshold value shall be readily appreciated by those of ordinary skill in the art, and thus will not be further described herein.

For example, it is assumed that the mobile communication system MCS of the present invention categorizes the priority values into high priority values, medium priority values and low priority values, and the correspondence relationships between each of the three kinds of priority values and the initial available preamble subset as well as the largest available preamble subset are respectively as follows: the initial available preamble subset corresponding to the high priority value is the preamble subset B₅ (i.e., the initial value of j is equal to 5) and the largest available preamble subset corresponding to the high priority value is also the preamble subset B₅ (i.e., m is equal to 5); the initial available preamble subset corresponding to the medium priority value is the preamble subset B₂ (i.e., the initial value of j is equal to 2) and the largest available preamble subset corresponding to the medium priority value is the preamble subset B₅ (i.e., m is equal to 5); and the initial available preamble subset corresponding to the low priority value is the preamble subset B₁ (i.e., the initial value of j is equal to 1) and the largest available preamble subset corresponding to the low priority value is the preamble subset B₄ (i.e., m is equal to 4). Therefore, the available preamble subsets corresponding to each of the priority values are as depicted in the Table 2.

TABLE 2

| Priority value | Available preamble subsets |
|---|---|
| High priority value | Preamble subset B₅ |
| Medium priority value | Preamble subsets B₂ \grave{ } B₃ \grave{ } B₄ \grave{ } B₅ |
| Low priority value | Preamble subsets B₁ \grave{ } B₂ \grave{ } B₃ \grave{ } B₄ |

When the priority value of the user equipment UE1 is the high priority value, the initial available preamble subset of the user equipment UE1 is the preamble subset B₅ and the largest available preamble subset thereof is also the preamble subset B₅. When the random access procedure is initiated, the user equipment UE1 selects a preamble randomly from the preamble subset B₅, and generates a random access request message 102 according to the selected preamble. Thereafter, the user equipment UE1 transmits the random access request message 102 to the base station BS.

When the preamble in the random access request message 102 collides with the preamble in the random access request message transmitted by other wireless devices, the base station BS cannot detect the preamble in the random access request message 102 and thus will not transmit a random access response message to the user equipment UE1. Therefore, the user equipment UE1 determines whether j is equal to m when a random access response message is not received from the base station BS within a preset time. Because the initial value of j is 5 and m is also equal to 5 when the priority value is the high priority value, the user equipment UE1 keeps j equaling to 5 and will not set j=j+1.

Thereafter, the user equipment UE1 re-selects a new preamble randomly from the preamble subset B₅, and again generates and transmits a random access request message 102 to the base station BS according to the selected preamble. If the preamble collision occurs again, then the user equipment UE1 repeats the aforesaid operations until the random access response message is received from the base station BS or until the number of transmissions of the random access request messages 102 reaches a threshold value. If the random access response message is received from the base station BS by the user equipment UE1 within a preset time (i.e., no preamble collision occurs), then the user equipment UE1 continues to execute the subsequent operations in the random access procedure in response to the random access response message.

When the priority value of the user equipment UE2 is the medium priority value, the initial available preamble subset of the user equipment UE2 is the preamble subset B₂ and the largest available preamble subset thereof is the preamble subset B₅. When the random access procedure is initiated, the user equipment UE2 selects a preamble randomly from the preamble subset B₂, and generates a random access request message 202 according to the selected preamble. Thereafter, the user equipment UE2 transmits the random access request message 202 to the base station BS.

When the preamble in the random access request message 202 collides with the preamble in the random access request message transmitted by other wireless devices, the base station BS cannot detect the preamble in the random access request message 202 and thus will not transmit a random access response message to the user equipment UE2. Therefore, the user equipment UE2 determines whether j is equal to m if a random access response message is not received from the base station BS within a preset time. Because the initial value of j is 2 and m is equal to 5 (i.e., j is not equal to m) when the priority value is the medium priority value, the user equipment UE2 sets j=j+1, i.e., sets j to 3.

Thereafter, the user equipment UE2 selects a new preamble randomly from the preamble subset B₃, and again generates and transmits a random access request message 202 to the base station BS according to the selected preamble. If the preamble collision occurs again, then the user equipment UE2 sets j=j+1, i.e., sets j to 4. Next, the user equipment UE2 selects a new preamble randomly from the preamble subset B₄, and again generates and transmits a random access request message 202 to the base station BS according to the selected preamble.

If the random access response message is received from the base station BS by the user equipment UE2 within a preset time (i.e., no preamble collision occurs), then the user equipment UE2 continues to execute the subsequent operations in the random access procedure in response to the random access response message. However, if the preamble collision occurs again, then the user equipment continues to set j=j+1, i.e., set j to 5. Next, the user equipment UE2 selects a new preamble randomly from the preamble subset B₅, and again generates and transmits a random access request message 202 to the base station BS according to the selected preamble.

Thereafter, if the preamble collision occurs again, then the user equipment UE2 re-selects a new preamble randomly from the preamble subset B₅ because j has been set to 5 and is equal to m, and again generates and transmits a random access request message 202 to the base station BS according to the selected preamble. If the preamble collision occurs again, then the user equipment UE2 repeats the aforesaid operations until the random access response message is received from the base station BS or until the number of transmissions of the random access request messages 202 reaches a threshold value.

When the priority value of the smart meter SM is the low priority value, the initial available preamble subset of the smart meter SM is the preamble subset B₁ and the largest available preamble subset thereof is the preamble subset B₄. When the random access procedure is initiated, the smart meter SM selects a preamble randomly from the preamble subset B₁, and generates a random access request message 302 according to the selected preamble. Thereafter, the smart meter SM transmits the random access request message 302 to the base station BS. When the preamble in the random access request message 302 collides with the preamble in the random access request message transmitted by other wireless devices, the base station BS cannot detect the preamble in the random access request message 302 and thus will not transmit a random access response message to the smart meter SM. Therefore, the smart meter SM determines whether j is equal to m if a random access response message is not received from the base station BS within a preset time. Because the initial value of j is 1 and m is equal to 4 (i.e., j is not equal to m) when the priority value is the low priority value, the smart meter SM sets j=j+1, i.e., sets j to 2.

Thereafter, the smart meter SM selects a new preamble randomly from the preamble subset B₂, and again generates and transmits a random access request message 302 to the base station BS according to the selected preamble. If the preamble collision occurs again, then the user equipment sets j=j+1, i.e., sets j to 3. Next, the smart meter SM selects a new preamble randomly from the preamble subset B₃, and again generates and transmits a random access request message 302 to the base station BS according to the selected preamble.

If the random access response message is received from the base station BS by the smart meter SM within a preset time (i.e., no preamble collision occurs), then the smart meter SM continues to execute the subsequent operations in the random access procedure in response to the random access response message. However, if the preamble collision occurs again, then the smart meter SM continues to set j=j+1, i.e., set j to 4. Next, the smart meter SM selects a new preamble randomly from the preamble subset B₄, and again generates and transmits a random access request message 302 to the base station BS according to the selected preamble.

Thereafter, if the preamble collision occurs again, then the smart meter SM re-selects a new preamble randomly from the preamble subset B₄ because j has been set to 4 and is equal to m, and again generates and transmits a random access request message 302 to the base station BS according to the selected preamble. If the preamble collision occurs again, then the smart meter SM repeats the aforesaid operations until the random access response message is received from the base station BS or until the number of transmissions of the random access request messages 302 reaches a threshold value.

As can be known from the above descriptions, under the random access mechanism of the present invention, the wireless devices with different priority values select preambles randomly from different preamble subsets when performing the random access procedure. So the present invention can reduce the possibility that the wireless device with a high priority value and the wireless device with a low priority value select the same preamble at the same time and cause the preamble collisions, thereby improving the probability of successfully executing the random access by the wireless device with the high priority value. Moreover, the preamble collision gradually enables the wireless device with a low priority value to be able to use the larger preamble subset, thereby gradually reducing the probability of preamble collisions between wireless devices with low priority values. Therefore, the random access mechanism of the present invention adopts a code-domain backoff mechanism to reduce the probability of preamble collisions.

It shall be appreciated that, in addition to the aforesaid operations, the random access mechanism of the present invention may also additionally adopt other preamble collision mechanisms, e.g., a time-domain backoff mechanism. In other words, the wireless device randomly generates a waiting time if the random access response message is not received from the base station within the preset time, and selects a new preamble randomly from the next preamble subset after the waiting time, and then again generates and transmits a random access request message according to the selected preamble.

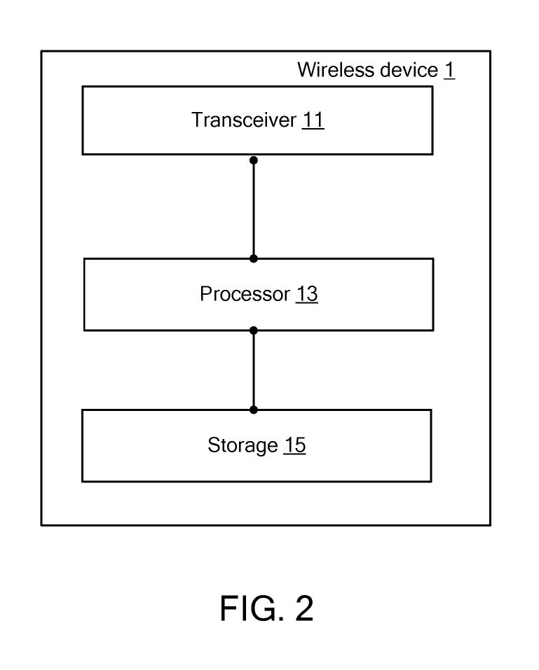

Please refer to FIG. 2 for a second embodiment of the present invention, and FIG. 2 is a schematic view of a wireless device 1 of the present invention. The wireless device 1 is a wireless device with the communication function, e.g., one of the user equipment UE1, the user equipment UE2 and the smart meter SM in the first embodiment. As described above, the mobile communication system MCS defines a plurality of preambles and N preamble subsets, where N is a positive integer. Each of the N preamble subsets has a part of the preambles. The i^{th} preamble subset includes the (i−1)^{th} preamble subset, where i a positive integer from 2 to N. The union of the N preamble subsets is all of the preambles.

The wireless device 1 comprises a transceiver 11, a processor 13 and a storage 15. The storage 15 stores the preambles, the N preamble subsets and a priority value. The priority value corresponds to an initial available preamble subset and a largest available preamble subset in the N preamble subsets.

The processor 13 is electrically connected to the transceiver 11 and the storage 15 and is configured to execute the following steps: (a) selecting a preamble randomly from a j^{th} preamble subset, where an initial value of j corresponds to the initial available preamble subset and is a positive integer from 1 to N; (b) generating a random access request message according to the selected preamble; (c) transmitting the random access request message to a base station via the transceiver 11; (d) when a random access response message is not received from the base station via the transceiver 11 within a preset time, determining whether j is equal to m and setting j=j+1 if j is not equal to m, where m corresponds to the largest available preamble subset and is a positive integer from the initial value of j to N; and (e) repeating the steps (a) to (d) after the step (d) until the random access response message is received from the base station or until the number of transmissions of the random access request messages reaches a threshold value.

In an embodiment, the processor 13 further receives via the transceiver 11 a system message broadcasted by the base station. The system message carries information of the N preamble subsets. Therefore, after receiving the system message, the processor 13 can extract the N preamble subsets from the system message and store the N preamble subsets into the storage 15. However, in another embodiment, the wireless device 1 may further comprise a SIM card slot (not shown) electrically connected to the processor 13. The SIM card slot is adapted to receive an SIM card. Accordingly, the processor 13 can reads the N preamble subsets and the priority value from the SIM card via the SIM card slot.

As with the exemplary example in the first embodiment, the priority value of the wireless device 1 represents a high priority when the wireless device 1 is the user equipment UE1, so both j and m are equal to N. Moreover, the priority value of the wireless device 1 represents a medium priority when the wireless device 1 is the user equipment UE2, so the initial value of j is not equal to 1 and m is equal to N. Additionally, the priority value of the wireless device 1 represents a low priority when the wireless device 1 is the smart meter SM, so the initial value of j is equal to 1 and m is not equal to N. However, those exemplary examples are not intended to limit the scope of the present invention. As can be readily appreciated by those of ordinary skill in the art based on the above descriptions, various embodiments for setting the initial value of j and the value of m based on the priority value can be adjusted by the operator of the mobile communication system MCS depending on requirements in the practical operation, so the setting of various priority values, the initial value of j and the value of m falls within the scope of the present invention.

In another embodiment, the aforesaid step (d) may further comprise the following steps: randomly generating a waiting time if the random access response message is not received from the base station via the transceiver 11 within the preset time, and executing the step (e) after the waiting time. In other words, the random access mechanism of the present invention may also additionally adopt the time-domain backoff mechanism.

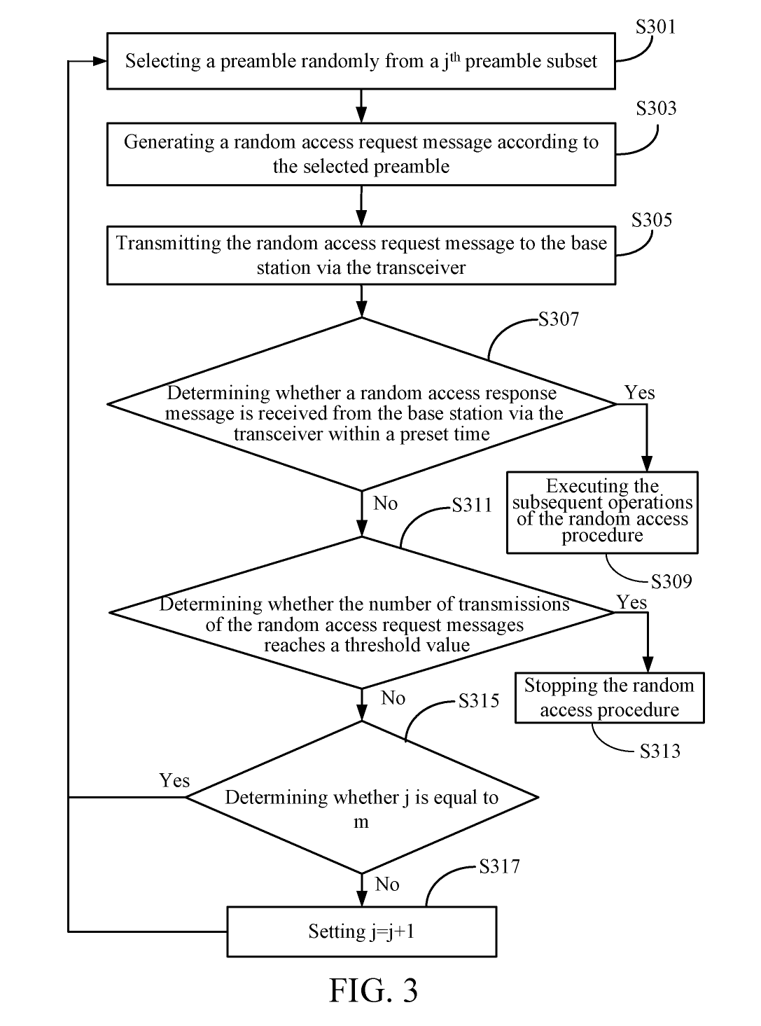

Please refer to FIG. 3 for a third embodiment of the present invention, and FIG. 3 is a flowchart diagram of a random access method of the present invention. The random access method of the present invention is used for a wireless device in a mobile communication system (e.g., the wireless device 1 in the aforesaid mobile communication system MCS).

The mobile communication system MCS defines a plurality of preambles and N preamble subsets, where N is a positive integer. Each of the N preamble subsets has a part of the preambles. The preamble subsets have a set inclusion relationship therebetween, i.e., the i^{th} preamble subset includes an (i−1)^{th} preamble subset, where i a positive integer from 2 to N. The union of the N preamble subsets is all of the preambles. The wireless device 1 comprises a transceiver, a processor and a storage. The storage stores the preambles, the N preamble subsets and a priority value. The priority value corresponds to an initial available preamble subset and a largest available preamble subset in the N preamble subsets. The random access method is executed by the processor.

First, in step S301, a preamble is selected randomly from a j^{th} preamble subset, where an initial value of j corresponds to the initial available preamble subset and is a positive integer from 1 to N. Next, in step S303, a random access request message is generated according to the selected preamble, and in step S305, the random access request message is transmitted to the base station via the transceiver. Thereafter, in step S307, it is determined whether a random access response message is received from the base station via the transceiver within a preset time. After the random access response message is received, step S309 is executed to execute the subsequent operations of the random access procedure.

On the contrary, if a random access response message is not received from the base station via the transceiver within a preset time, then step S311 is executed to determine whether the number of transmissions of the random access request messages a threshold value. If the number of transmissions of the random access request messages reaches the threshold value, then step S313 is executed to stop the random access procedure. If the number of transmissions of the random access request messages does not reach the threshold value, then step S315 is executed to determine whether j is equal to m, and m corresponds to the largest available preamble subset and is a positive integer from the initial value of j to N, i.e., m>=j. Next, step S317 is executed to set j=j+1 if j is not equal to m, and then the method returns to the step S301. On the other hand, if j is equal to m, then the method directly returns to the step S301.

In another embodiment, the random access method of the present invention further comprises the step of: receiving, via the transceiver, a system message broadcasted by the base station. The system message carries the N preamble subsets. Additionally, in another embodiment, the random access method of the present invention further comprises the following steps when the wireless device further comprises a SIM card slot electrically connected to the processor and the SIM card slot is adapted to receive an SIM card: reading the N preamble subsets and the priority value from the SIM card via the SIM card slot.

Moreover, in another embodiment, the random access method of the present invention further comprises the following steps after determining that the number of transmissions of the random access request messages does not reach the threshold value: randomly generating a waiting time, and returning to the step S301 after the waiting time. It shall be appreciated that, in this embodiment, the step S315 and the step S317 may be executed in the waiting time.

In addition to the aforesaid steps, the random access method of the present invention can also execute all the operations and have all the corresponding functions set forth in the aforesaid embodiments. How this embodiment executes these operations and has those functions will be readily appreciated by those of ordinary skill in the art based on the explanation of the aforesaid embodiments, and thus will not be further described herein.

According to the above descriptions, through the random access mechanism of the present invention, the wireless devices with different priority values select preambles randomly from different preamble subsets when performing the random access procedure. This can reduce the probability of preamble collisions resulting from the same preamble selected by high-priority wireless devices and low-priority wireless devices at the same time, thereby improving the probability of successfully executing the random access by the wireless device with the high priority value.

Moreover, the wireless device with a low priority value can be gradually allowed to use the larger preamble subset with the preamble collision occurs, thereby gradually reducing the probability of preamble collision between wireless devices with low priority values. Therefore, as compared to the conventional mobile communication system, the mobile communication system of the present invention can effectively reduce the possibility of preamble collisions resulting from the same preamble selected by multiple wireless devices at the same time, thereby improving the probability of successfully executing the random access procedure by the wireless devices and avoiding idleness of the radio resources of the base station.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A wireless device for a mobile communication system, the mobile communication system defining a plurality of preambles and N preamble subsets, where N is a positive integer, each of the N preamble subsets having a part of the preambles, the preamble subsets having a set inclusion relationship therebetween, an i^{th} preamble subset including an (i−1)^{th} preamble subset, where i being a positive integer from 2 to N, and the union of the N preamble subsets being consisted of the preambles, the wireless device comprising:
a transceiver;
a storage, being configured to store the preambles, the N preamble subsets and a priority value, the priority value corresponding to an initial available preamble subset and a largest available preamble subset; and
a processor electrically connected to the transceiver and the storage, being configured to execute the following steps:
(a) selecting a preamble randomly from a j^{th} preamble subset, where an initial value of j corresponds to the initial available preamble subset and is a positive integer from 1 to N;
(b) generating a random access request message according to the selected preamble;
(c) transmitting the random access request message to a base station via the transceiver;
(d) when a random access response message is not received from the base station via the transceiver within a preset time, determining whether j is equal to m and setting j=j+1 if j is not equal to m, wherein m corresponds to the largest available preamble subset and is a positive integer from the initial value of j to N; and
(e) repeating the steps (a) to (d) after the step (d) until the random access response message is received from the base station or until a number of transmissions of the random access request messages reaches a threshold value.

2. The wireless device of claim 1, wherein the processor further receives, via the transceiver, a system message broadcasted by the base station, and the system message carries the N preamble subsets.

3. The wireless device of claim 1, further comprising a Subscriber Identity Module (SIM) card slot electrically connected to the processor, wherein the SIM card slot is configured to receive an SIM card, and the processor reads the N preamble subsets and the priority value from the SIM card via the SIM card slot.

4. The wireless device of claim 1, wherein the step (d) further comprises the following steps:
randomly generating a waiting time if the random access response message is not received from the base station via the transceiver within the preset time, and executing the step (e) after the waiting time.

5. The wireless device of claim 1, wherein the mobile communication system is a Long Term Evolution (LTE) communication system, and the number of the preambles is 64.

6. The wireless device of claim 1, wherein j and m are equal to N if the priority value represents a high priority.

7. The wireless device of claim 1, wherein the initial value of j is not equal to 1 and m is equal to N if the priority value represents a medium priority.

8. The wireless device of claim 1, wherein the initial value of j is equal to 1 and m is not equal to N if the priority value represents a low priority.

9. A random access method for a wireless device, the wireless device being used in a mobile communication system, the mobile communication system defining a plurality of preambles and N preamble subsets, where N is a positive integer, each of the N preamble subsets having a part of the preambles, the preamble subsets having a set inclusion relationship therebetween, with an i^{th} preamble subset including an (i−1)^{th} preamble subset, where i a positive integer from 2 to N, and the union of the N preamble subsets is all of the preambles, the wireless device comprising a transceiver, a storage and a processor, the storage storing the preambles, the N preamble subsets and a priority value, the priority value corresponding to an initial available preamble subset and a largest available preamble subset, the random access method being executed by the processor and comprising:
(a) selecting a preamble randomly from a j^{th} preamble subset, where an initial value of j corresponds to the initial available preamble subset and is a positive integer from 1 to N;
(b) generating a random access request message according to the selected preamble;
(c) transmitting the random access request message to a base station via the transceiver;
(d) when a random access response message is not received from the base station via the transceiver within a preset time, determining whether j is equal to m and setting j=j+1 if j is not equal to m, wherein m corresponds to the largest available preamble subset and is a positive integer from the initial value of j to N; and
(e) repeating the steps (a) to (d) after the step (d) until the random access response message is received from the base station or until the number of transmissions of the random access request messages reaches a threshold value.

10. The random access method of claim 9, further comprising:
receiving, via the transceiver, a system message broadcasted by the base station, and the system message carries the N preamble subsets.

11. The random access method of claim 9, wherein the wireless device further comprises a Subscriber Identity Module (SIM) card slot electrically connected to the processor, wherein the SIM card slot is configured to receive an SIM card, the random access method further comprising:
reading the N preamble subsets and the priority value from the SIM card via the SIM card slot.

12. The random access method of claim 9, wherein the step (d) further comprises:
randomly generating a waiting time if the random access response message is not received from the base station via the transceiver within the preset time, and executing the step (e) after the waiting time.

13. The random access method of claim 9, wherein the mobile communication system is a Long Term Evolution (LTE) communication system, and the number of the preambles is 64.

14. The random access method of claim 9, wherein j and m are equal to N if the priority value represents a high priority.

15. The random access method of claim 9, wherein the initial value of j is not equal to 1 and m is equal to N if the priority value represents a medium priority.

16. The random access method of claim 9, wherein the initial value of j is equal to 1 and m is not equal to N if the priority value represents a low priority.
